(19) United States
(12) Patent Application Publication
(10) Pub. No.: US 2011/0320495 A1
(43) Pub. Date: Dec. 29, 2011

(54) PERSONAL INFORMATION TRACKING, RECORDING, REPORTING AND SHARING SYSTEM AND METHOD

(76) Inventors: Guy Levy-Yurista, Rockville, MD (US); David Pinto, Rockville, MD (US)

(21) Appl. No.: 13/122,946

(22) PCT Filed: Oct. 27, 2009
(86) PCT No.: PCT/US09/62181

§ 371 Date: Jul. 1, 2011

Related U.S. Application Data
(60) Provisional application No. 61/197,322, filed on Oct. 27, 2008.

(51) Int. Cl. G06F 17/30

(52) U.S. Cl. 707/780; 707/E17.018; 707/E17.014

(57) ABSTRACT

The invention relates to automatic logging of people's lives by combining a geo-location tracking system, a data storage service and sharing services. In particular, a method and a system for location reporting using geo-location tracking devices, such as mobile communication devices, social networks and data storage and manipulation services. The data points collected from geo-location tracking receivers are then associated with information collected from various external information sources provided by the user and presented as points, milestones, or periods along the user's path, past, present and future.

### CROSS-REFERENCE

This application claims the benefit of U.S. Provisional Application No. 61/197,322, filed Oct. 27, 2008, which application is incorporated herein by reference.

### BACKGROUND OF THE INVENTION

Over the past several years we witnessed the development of online services that allow users to upload personal and public information to online storage locations. These new set of services allow users to save their data and media online, whether comprised of text, pictures, video or other media forms. For example, online services such as Picasa or Flickr allow users to upload a large number of pictures to these services and view them from any internet connected device, manipulate them, enhance them and even share them with people of their choosing or make them available to the general public.

Furthermore, over the past several years a new set of services has appeared that allows users to maintain, develop and enhance their social connections over the internet. These services were dubbed Social Networks as they allow users a view of their human interactions, whether personal or business oriented. Services such as Facebook or LinkedIn allow users to maintain a list of people they would like to stay connected to and then share information with them at their choosing.

Parallel and independent to the development of these online services, geo-location tracking systems have advanced considerably over the past few years. Such systems include but are not limited to Global Navigation Satellite Systems (GNSS, also known in the USA as GPS), cell-site triangulation, Wi-Fi triangulation, Wi-Max triangulation and others. Global Positioning System (GPS) technology has enabled the integration of GPS chips in many common devices, most notably cell phones. It is expected that the GPS and other geo-location tracking technologies shall become so ubiquitous they will seamlessly integrate in our daily lives. Cell phones, digital cameras and cars are now equipped with GPS chips, and more and more devices are expected to include similar geo-location tracking technology over the coming years.

The current services mentioned above for storing and reporting information and media and sharing it with friends and other contacts have thus far served to provide only a limited, fragmented view of a person's life. Whether these were photo albums saved on one website, personal blogs displayed on a second one or business contacts listed on yet a different online platform, none of these services allowed a user to maintain a complete and contiguous picture of his or her path through life. Even a user who is interested in maintaining a unified record of his or her experiences and social connections needs to leverage several disjointed services to provide him or her with a way to capture his or her daily events and interactions. These services may include blog platforms, picture storage, sharing services, video content platforms and others.

### SUMMARY OF THE INVENTION

The invention relates to automatic logging of people's lives combining a geo-location tracking system, a data storage service and sharing services. In particular, methods and systems for location reporting may use geo-location tracking devices such as mobile communication devices, social networks and data storage and manipulation services. The data points collected from geo-location tracking devices may then be associated with information collected from various external information sources provided by the user and presented as points, milestones, or periods along the user's path, past and future. Moreover, the systems and methods may allow the sharing of multiple personal information paths amongst many users to display multiple paths of several people at the same time overlaid on the same screen or map.

One aspect of the invention may provide a system for displaying user-associated geo-location information. The system may comprise a database comprising location and time data for a subject, wherein said subject location and time data is collected via a geo-location tracking device. The system may also comprise a server in communication with the geo-location tracking device and in communication with a display device, wherein the display device simultaneously shows all the subject's locations within a specified time range, based on the subject location and time data.

The system may include one or more of the following features. The specified time range may be determined by a user of the display device. The display device may be a computer, a mobile phone, or a personal device assistant. The display device may show the subject's location within the specified time range using at least one of the following: a map, a chart, a timeline, or a list. In some instances, the geo-location tracking device may be a portable device. For example the geo-location tracking device may be at least one of the following: a mobile phone, a personal device assistant, or a laptop computer.

In some embodiments, the subject may control whether a user of the display device can see the subject's location within the specified time range. A user of the display device may be able to see the location within a specified time range for multiple subjects. In some instances, the user of the display device is the subject. Multiple subjects may have access to the user's data. A privacy setting configurable by the user may determine which of the user's data that the multiple subjects can access. The display device may be configured to allow the user to send a message to the subject on the subject's geo-location tracking device or vice versa.

Another aspect of the invention may be directed to a method for displaying user-associated geo-location information. The method may comprise the steps of collecting subject location and time data using a geo-location tracking device, wherein the subject location and time data includes at least one data point; storing the subject location and time data within a database; and displaying, on a display device, a map simultaneously showing all the subject's location within a specified time range, based on the subject location and time data.

In some embodiments, the geo-location tracking device, the database, and the display device may communicate over a network. In some instances, at least one of the geo-location tracking device, the database, and the display device may communicate wirelessly. The specified time range may be at least one of the following: a current point in time, a point in time in the past, a past hour, a past day, a past week, a past month, or a past year. The specified time range may include a future time reflecting the subject's anticipated location and time.

In accordance with another aspect of the invention, a system for geo-location experience tracking may comprise a database comprising location and time data for a user, wherein said user location and time data is collected via a geo-location tracking device. The system may further comprise a server in communication with the geo-location tracking device and in communication with a third party service, wherein the third party service provides third party user-associated information to the server, which compares and associates the third party user-associated information with the user location and time data.

The geo-location tracking device may be one of the following: a mobile phone, a personal device assistant, or a laptop computer. The geo-location tracking device may utilize global navigation satellite system (GNSS) receiver such as a GPS receiver or extrapolation to determine user location data. The third party service may include at least one of the following: social networking site, blog site, an online photo storage, an online video storage, a calendar, or a communications tool. The third party service may also include publicly available data. The publicly available data may include at least one of the following: pictures, video, website information, website data, weather, traffic information, or online data entries.

A method for geo-location experience tracking may be provided in accordance with an aspect of the invention. The method may comprise collecting user location and time data using a geo-location tracking device, wherein the user location and time data includes at least one data point; storing the user location and time data within a database; querying a third party service for third party user-associated information; comparing the user location and time data with the third party user-associated information; and associating the third party user-associated information with at least one data point.

The method may further comprise providing information to the geo-location tracking device based on said associating third party user-associated information with at least one data point. In some embodiments, the method may further comprise alerting the user when a contact status, location or other aspect has been changed or updated. The method may also include the step of storing the third party user-associated information that has been associated with at least one data point in the database.

Other goals and advantages of the invention will be further appreciated and understood when considered in conjunction with the following description and accompanying drawings. While the following description may contain specific details describing particular embodiments of the invention, this should not be construed as limitations to the scope of the invention but rather as an exemplification of preferable embodiments. For each aspect of the invention, many variations are possible as suggested herein that are known to those of ordinary skill in the art. A variety of changes and modifications can be made within the scope of the invention without departing from the spirit thereof.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings of which:

FIG. 1 is a block diagram of a system and method in accordance with the present invention.

FIG. 2 is a block diagram of the overall system and method as it relates the collected information to the user in accordance with aspects of the invention.

FIG. 3 is a pictorial view of user path display in accordance with aspects of the invention.

FIG. 4 is an additional pictorial view of a user path display.

FIGS. 5a and 5b show additional examples of a user path display.

FIG. 6 is a pictorial view of multiple user paths display in accordance with aspects of the invention.

### DETAILED DESCRIPTION OF THE INVENTION

While preferable embodiments of the invention have been shown and described herein, it will be obvious to those skilled in the art that such embodiments are provided by way of example only. Numerous variations, changes, and substitutions will now occur to those skilled in the art without departing from the invention. It should be understood that various alternatives to the embodiments of the invention described herein may be employed in practicing the invention.

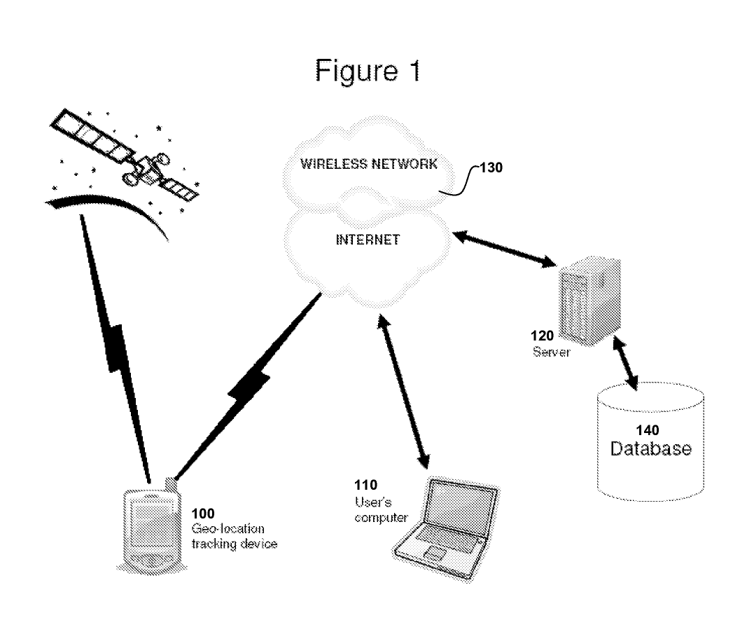

FIG. 1 is a block diagram of a system with geo-location experience tracking in accordance an aspect of the invention. The geo-location experience tracking system may include a geo-location tracking device 100, a user's computer 110 and a server 120. The geo-location tracking device, the user's computer, and the server may communicate with one another over a network 130. The server may be in communication with a database 140. The database may be part of the server or may be provided separate from the server. The server 120 may communicate with the database 140 over a network 130 or directly. The server may be a user life path geo-location server, which may process and/or handle information relating to a user life path, which may include user location and time data, or any other data that may involve a user's experience associated with the location and time data.

The network 130 may be the Internet, or any other wide area network, or may be a local area network. Any of the connections between the various devices may occur over the same network or over different network. Any of the devices, such as the geo-location tracking device 100, user's computer 110, and/or server 120 may communicate wirelessly or over a wired connection.

In some instances, the geo-location tracking device 100 may be a mobile device. Some examples of a geo-location tracking device may include but are not limited to a mobile phone, a personal digital assistant (PDA), laptop computer, pager, any other networked device, or any device that may communicate wirelessly or with a satellite or tower, which may include those that may also be used for a user's computer. The geo-location tracking device may be global navigation satellite system (GNSS) enabled. Alternatively, the position of the geo-location tracking device may be triangulated or extrapolated, such as using techniques described herein. For example, the location can be obtained by other means, such as manual input, a dump from a GNSS tracking device, or any other device or method that may be known or later developed in the art. User geo-location data can be collected remotely or indirectly in methods other than or in addition to a device carried by the user. For example, a user's vehicle may be tracked, or user's location may be tracked via a cell phone network or via a satellite system. Pre-existing systems may be utilized to assist with user tracking.

The user's computer 110 may or may not be mobile. The user's computer may apply to any type of networked device, including but not limited to a personal computer, server computer, or laptop computer; personal digital assistants (PDAs) such as a Palm-based device or Windows CE device; phones such as cellular phones or location-aware portable devices (such as GPS); a roaming device, such as a network-connected roaming device; a wireless device such as a wireless email device or other device capable of communicating wirelessly with a computer network; or any other type of network device that may communicate over a network and handle electronic transactions.

The database 140 may have an integrated collection of logically related records, files, or consolidated into a common pool. The database may provide memory storage for data. In some embodiments, multiple servers and databases may be provided, which may contain multiple information sources. These multiple servers and/or databases may be connected to the user life path geo-location server.

Some aspects of the invention may provide systems and methods that allows a user to create, record, maintain, view and share information, representing their overall experiences and interactions in a unified form while leveraging online storage, sharing services, social networks, time management applications and devices, communication tools and services and geo-location tracking technology.

A user, who may own a cell phone or some other device with a geo-location tracking capability integrated in it, may install and run a software code on the device which then accesses the geo-location information and sends location and time data back to a server using an internet connection or other communications means. Any tangible computer readable media with logic, code, data, instructions, may be used to implement any software or steps or methodology. FIG. 1 depicts a block diagram of a system and method in accordance with the present invention.

Alternatively the proposed method and system could use an already existing geo-location tracking reporting mechanism that exists in the device and use it to collect and store the location and time data in a database.

The database may maintain a set of tables which contain the user account identifier information with a series of entries that contain the data received from the geo-location tracking device, including but not limited to location, direction, altitude, speed and time. Such data may be collectively referred to as user location and time data. The user location and time data may be stored as data points. For example, a data point may include location, direction, and/or speed data at a particular point in time.

As the user data is collected over a time period, such as a period of minutes, hours, days, weeks, months and years, his or her personal whereabouts, experiences and interactions may be continuously recorded in the database. The data may also be recorded at discrete intervals on a continuous basis. For example, the data may be recorded every second, few seconds, minute, few minutes, 10 minutes, half hour, hour, on a continuous basis. Alternatively, a user may set up time periods and frequency at which the user may wish the data to be collected. For example, during daytime hours, the user may record data more frequently than during nighttime hours.

The user also provides the service with his or her log-in credentials to various services he or she uses to keep track of information, representing experiences, events and connections in their life. For example, if the user uses the Flickr.com service to upload the pictures he takes, store them there and share them from there, then the system described in this invention will use the user's Flickr.com credentials to access the user's pictures on Flickr.com. The same may be true to any online service the user uses, including but not limited to a blogging service, a picture and/or video service, webmail service, instant messaging service, online calendar, a social network, and others. The system in this invention may also access the user's offline information, such as the user's own computer hard drive where data representing the user's experiences, events and connections may be stored, including but not limited to pictures, videos, email messages, instant messages, calendar entries, contact lists, and others.

The system may regularly scan these various online and offline data sources for updates and using the time and/or location information provided in these services, link specific entries on these services with the user location/time database table maintained by the new service by recording the URL information linking to the relevant entry in these services for each relevant data point or set of points. The system may also copy the full content of the linked information to its own servers to protect it from future damage and to allow easier access to it for the user. The system may scan or ping the various services on any schedule, which may or may not be determined by the user. For example, the personal information tracking system may scan other servers every 15 minutes or any other time period for updates. In some embodiments, when a user registered to the system, the user may also indicate one or more online or offline services that the user may wish the system to periodically scan. For example, the user may register various third party services that the user may have also subscribed to, such as a blogging service, a picture and/or video service, webmail service, instant messaging service, online calendar, a social network, and others. The user may register these other services by providing information such as a URL, user ID, and/or user password or other authentication. In some instances, the system may also scan additional services, which may include publicly available services.

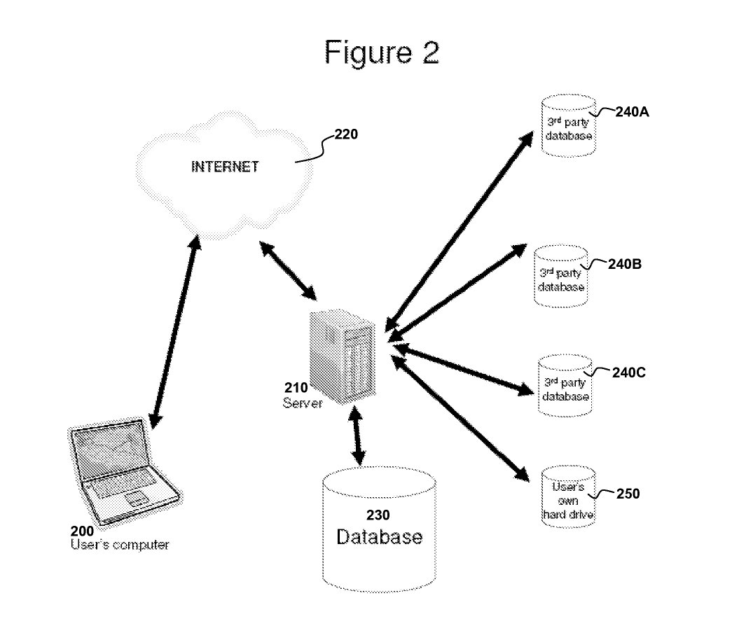

FIG. 2 depicts a block diagram of the overall system and method as it relates the collected information of the user in accordance with aspects of the invention. A user computer 200 may communicate with a server 210 over a network 220. The server 210 may communicate with a database 230. The server 210 may also communicate with one or more third party databases 240A, 240B, 240C. The server 210 may also communicate with the user's own hard drive 250.

The user display device, which may be a user computer, may communicate with the server 210, and the server may communicate with the database 230 in any way previously described. The database 230 may include user location and time information, links to third party databases 240A, 240B, 240C, or the user own information copied from his or her computer 250.

These services may include data that may be stored in third party databases 240A, 240B, 240C. In some instances, services may be provided by third party services. Such third party services may include private third parties or may provide access to publicly available data. In other instances, information may also be submitted directly by users to the system. Data collected may come automatically from a user's own computing device 200 (e.g., computer, laptop, PDA, cell phone, or any life-logging dedicated device which may be used to gather information about the user's life such as user location, time, photos, recorded experiences). Such data may include, for example, documents, email, instant messages, photos, or videos, which may be stored on the user's computing device 200.

Moreover, a copy of the user data, and not just the URL information linking to the data, may be stored in a database 230 maintained by the new service to ensure continuity and to prevent data loss impacted by third party services change of policy, bankruptcy or other reasons.

The result is a set of database tables and files containing information accrued and reported throughout the user's use of the new service with time and location stamps associated with specific information entries that the user provided to his or her services of choice, whether these are blog entries, calendar entries, emails, pictures, video clips, instant messages, or other information, representing experiences, interactions or activities the user has recorded. Association between third party and other user-associated information with a data point (e.g., location and time data) may occur via comparing a digital element's time stamp to the user list of geo-location points in time.

Next, by gaining access from the user to social networks and other services where the user can share his or her information with friends, the new service would offer to share the user's recorded path and associated information, representing experiences and events with his or her friends and other contacts or even the general public.

In some instances, the system may include time and/or location data for a subject, who may or may not be a user of the system. For example, the subject may provide the system with the subject's geo-location tracking device information without actually registering with the system. In such situations, users of the system may add the subject as a contact. In other embodiments, a subject may always be a user of the system.

These contacts may be divided into various classifications, such as family, friends, work colleagues, business partners, etc.

Alternatively or in parallel these contacts may be associated with different privacy levels. A subject may control the amount of information that may be revealed to a user that may be viewing their information. The user may similarly control the amount of the user's information that is viewed by other users. These controls may be done on an individual basis or by contact class.

Different contact classes or even different contacts may be presented with a portion of the user data per the user's choice.

The user may also decide to create delayed information sharing with some or all of his or her contacts or even the general public. Thus, the user may choose to introduce a delay in the presentation of his or her location or activities. For example the user may elect to release the information of his or her whereabouts only with a 24 hours delay or some other delay period, in order to better protect his or her privacy.

A user interface or a display may be provided in accordance with the invention herein may be displayed across a network such as the Internet. For example, as shown in FIG. 1, an implementation may include a user computer comprising a video display with at least one display page comprising data. The data may include subject location and time data, which may include data relating to the location of the subject at a particular time. Such data may include speed and direction data. Other data associated with the subject's location and/or time may also be displayed. For example, photos that might have been taken at a particular place and time may be associated with the subject location and time data, and may also be visually mapped to the subject's location and time on the display.

A display may be provided on an electronic device. Video displays may include devices upon which information may be displayed in a manner perceptible to a user, such as, for example, a computer monitor, cathode ray tube, liquid crystal display, light emitting diode display, touchpad or touchscreen display, and/or other means known in the art for emitting a visually perceptible output. Video displays may be electronically connected to a user computer according to hardware and software known in the art.

In one implementation of the invention, a display page may include a computer file residing in memory which may be transmitted from a server over a network to a client computer, which can store it in memory. A user client computer may receive computer readable media, which may contain instructions, logic, data, or code that may be stored in persistent or temporary memory of the client computer, or may somehow affect or initiate action by a client computer. Similarly, one or more servers may communicate with one or more user client computers across a network, and may transmit computer files residing in memory. The network, for example, can include the Internet or any network for connecting one or more clients to one or more servers.

At a user's computer, the display page may be interpreted by software residing in memory of the user computer, causing the computer file to be displayed on a video display in a manner perceivable by a user. Any computer readable media with logic, code, data, instructions, may be used to implement any software or steps or methodology. Where a network comprises the Internet, a display page may comprise a webpage of a type known in the art.

The system and method provides the user with a webpage or personalized website that is associated with his or her account with the new service and the database maintained by the service. On that webpage the user can view his or her path as described by the database as well as the linked entries from other services. The data is then presented on a map or over some time line with indicators that represent the links to the data that were connected from the other online services. For example, when a user views his or her life path over a time and place where he or she took a picture, a thumbnail picture could appear on mouse hover over the relevant location and show a preview of the picture that was taken at that place and time. By clicking on this thumbnail or other indicator the user may be linked to the online service where his or her picture is stored.

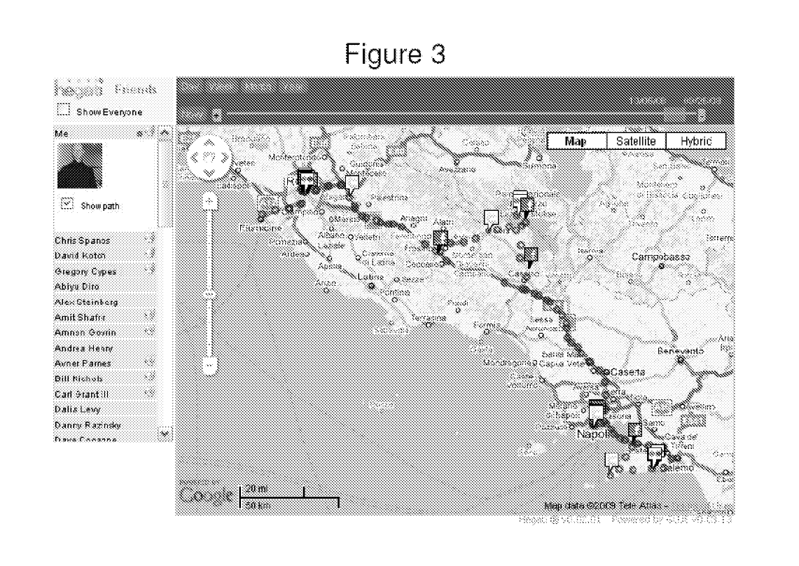

FIGS. 3-5 depict pictorial views of user path display in accordance with aspects of the invention. For example the display may show the user path on a map. Alternatively, the display may show the user path in any form, which may include a geographic map, a conceptual map (e.g., a showing connections between different users, places, times, etc.), a representative display (e.g., stylized rendering of a location, subject, or other attribute), a chart, a timeline, or a list.

FIG. 3 shows an example of a path on a geographic map with icons associated with other services. The icons may represent data from the other services that may be associated with the location and time of a data point of the path, and displayed in visual proximity to that data point. A geographic map may utilize features of pre-existing map programs including but not limited to Google maps, Mapquest, Yahoo Maps, and other map programs. Thus, various viewing types and navigational controls may be used.

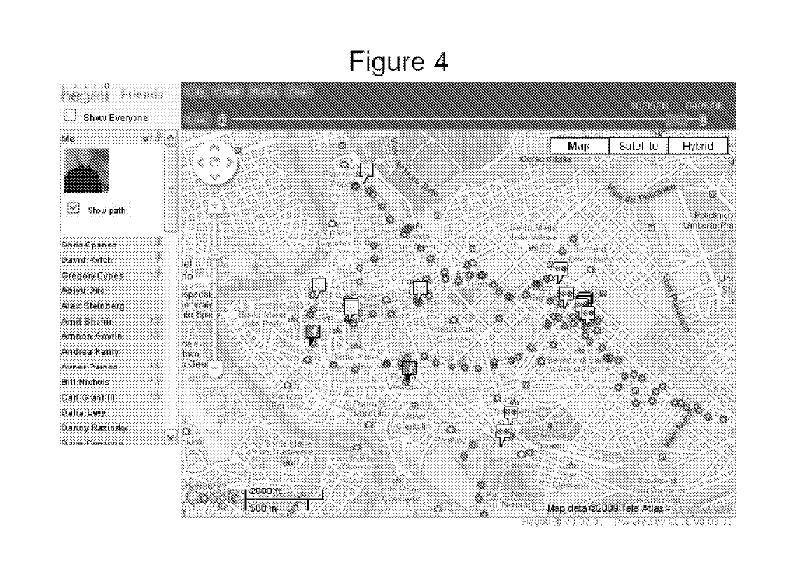

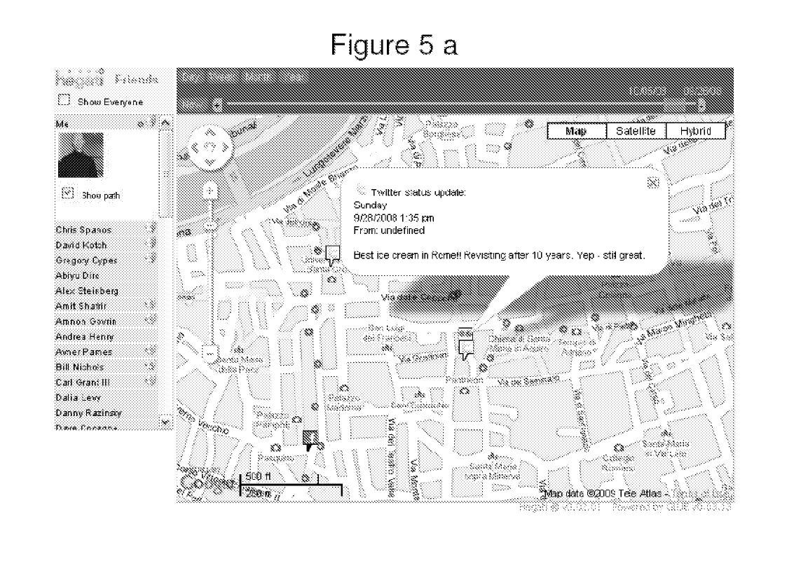

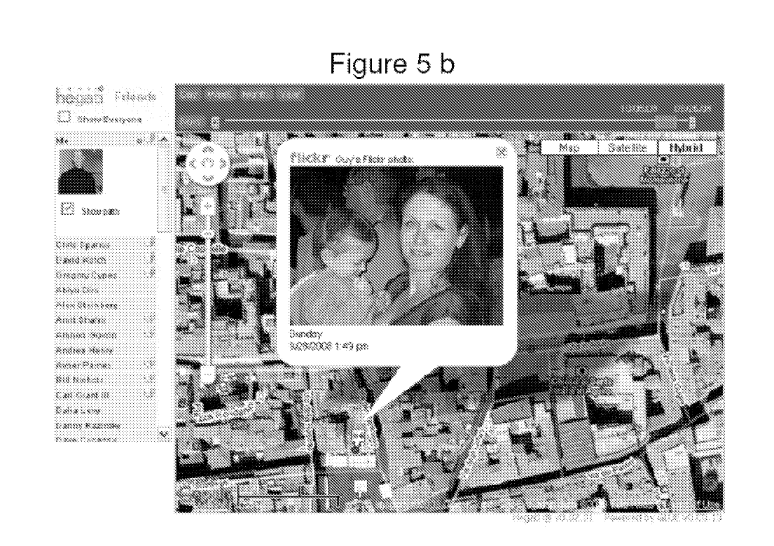

FIG. 4 shows a zoomed in map with a user path and associated icons. A street view may be provided. FIGS. 5a and 5b show how a preview or thumbnail may be displayed relating to data from other services or additional details submitted by the user.

A map may show the location of the user within a specified time range. The map may simultaneously display all the various locations of the user within that time. For example, if data points are gathered every minute, and the user's path is displayed over the past half hour, about 30 data points showing the user's location at each of those times may be displayed on the map. The specified time range may be determined by the user. The specified time range may be selected to be a current point in time, a point in time in the past, a time interval such as a past minute, a past hour, a past day, a past week, a past month, or a past year. The specified time range may be a time interval that may include the most recent past time interval (to include the current time) or may be the time interval at any point in the past (which need not include the current time). The specified time range may include a future time reflecting the subject's anticipated location and time.

The user may be able to filter the data displayed on his or her personalized webpage according to various parameters including but not limited to time periods, areas of interest, a combination of the two, contact groups, data types, or other customized filters. Thus, the user may apply filtering to displayed data by various means, such as activities, behaviors, tags, reported status updates, photos/videos types/subjects, etc. User data may be directly edited on a map or other display scheme after the fact either by the user or viewers of such user data. In some instances, the user data associated with geo-location information may include all digitally available information relating to a user. The user may choose to hide some of the data or life path on a section of the map or a period in time. This may apply to viewing the user's own map, or when other users view the user's data. The user may choose to create a location specific or time specific obfuscation to hide his or her whereabouts when in a certain area or time of day, week, season, etc. In some instances, the display may also include a contact list which may list the user's contact and/or specify which contacts' location and time data are being displayed.

In addition, the new service will offer to store some of the data describing the user's experiences, events and contacts in a special database such that the user can have all his or her media and information stored in one location provided by the new service. For example, the new service can offer online photo storage, a calendar, a communications tool, a social connection management tool, also known as a social network, or any other such service that the users could find useful. These services can replicate and compliment any similar services available by other parties that are linked to the database as discussed above.

A display, such as a map, may display interaction between users of the service. For example, a map may display emails sent from a first user to a second user. This may be displayed as a thin line connecting the location from which such email was sent by one user and the location in which this email was received by another user. Or in the case of a photo containing several users the interaction may be depicted by a circle encompassing these users' life paths' intersection.

Furthermore, the user's map or other display form can also show the paths of some or all of his contacts according to the level of permission granted to the user by them. These various paths could be colored or marked in a way that distinguishes them from the user own path and from each other. By viewing the many paths of the user contacts the user will be able to get a dynamic picture of his or her life and his or her social interactions.

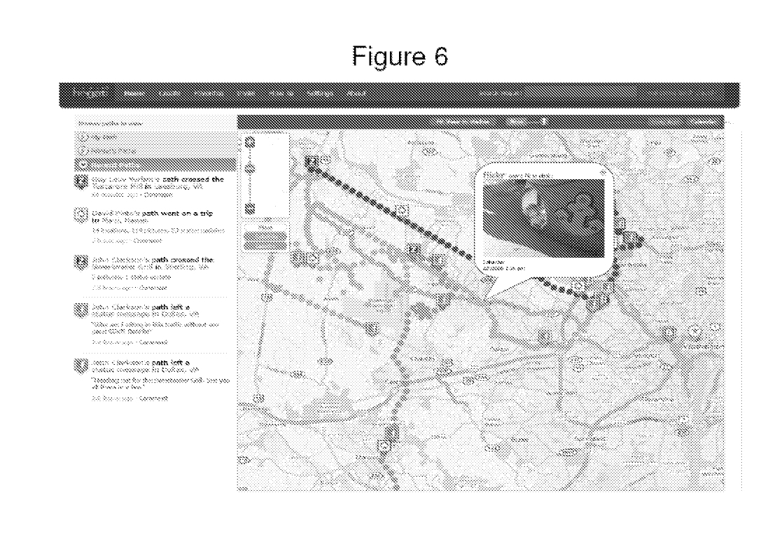

FIG. 6 depicts a pictorial view of multiple subject paths display in accordance with aspects of the invention. The multiple subject paths may be displayed if they fall within a specified time range and/or specified location. For example, all of the multiple subject paths shown may be for the same specified time range. In another example, all of the multiple subject paths that are displayed may fall within a geographical area, which may or may not be near the user's location. The display may be controllable so that the user may select which location to view.

As an enhancement to the invention, the system could use publicly available data, such as pictures, video, website information, weather data, traffic information, wikipedia entries and other sources of information to augment the level of information provided to a certain location or time period. The user can then choose whether to view this additional data or ignore it using the filters discussed above.

Furthermore, aspects of the invention include systems and methods for proactively alerting a user when a contact status, location or other aspect has been changed or updated. Alerts may also be provided when the user is in proximity to anyone or anything of interest. For example, if a user is near a contact, or if the user is near an event that the user has expressed interest in, an alert may be provided. Such alerts could include but are not limited to email notifications, instant messages, SMS or MMS notification to his or her cell phones or other means. This way the user will receive alerts regarding people he or she is interested to learn about, even without the need to constantly monitor the user's webpage with his or her contacts' information displayed. Alerts or reminders may be sent to users based on current location or expected location. These alerts and reminders may be related to other users, to locations of interest, to specific offers, which may or may not be time and location dependent. These may be delivered in a predicted manner related to user historical patterns, inferring from which the expected user's needs, actions, interactions, movement, etc. Services may be monetized via the alerts and/or reminders, or in any other manner discussed herein.

The system and method include open Application Program Interfaces (APIs) to allow other services to connect to it and augment it by adding information layers to the ones already displayed by it. This way new services created by third parties could leverage the new service's platform and enhance its value to the user.

The invention may advantageously provide the user with a way to communicate with his or her contacts, sharing information, media, or text, either in real time or via delayed delivery.

Such communication interactions could be represented visually as links between user paths on the user map or display screen. The new service could potentially provide such services which could include but are not limited to emails, instant messages, SMS, MMS, VoIP connection, video conferencing or other means. Users may also be able to send other users/contacts messages, coupons, virtual goods, etc., which may be based on the receiving user's activity or location.

Moreover, the system could provide a view into the expected future of the user. The new service can display and share where the user expects to be and when he or she will be at that expected location as well as the expected activity, event or experience and accompanying parties. All of this information would be fed into the new service similar to calendar entries or other organizing services. This way the user and his or her contacts will have a view as to the user's plans. User's contacts can then adjust their own activity and plans accordingly.

This feature of the invention could also serve as a new planning platform for the user, enhancing existing calendar applications and services by adding a location dimension as well as linking to other information sources. For example, the system could identify an expected trip to another city and could offer the user a variety of services he or she may need on their trip, such as local information, hotel rooms, rental car services, dining locations, etc.

In case where the geo-location tracking receiver has no signal reception or when the geo-location tracking device is turned off the system could extrapolate the user's location and time using various methods and algorithms. These interpolated paths could be presented on the screen or map to help the user complete his or her path.

For example, when a user is forced to turn off his or her geo-location tracking receiver during airplane travel, the system will identify that the geo-location data points appear to have disappeared near an airport and then have reappeared again near another airport at some future time. By retracing common flight routes the system can interpolate the user's path during the time no data was reported by his or her geo-location tracking receiver and present this interpolated route to the user.

The same type of path interpolation algorithm could be applied to include but not limited to, sea travel, train travel, and areas lacking geo-location tracking coverage.

An aspect of the invention is the creation of a large database analyzing people's location, speed and movement over time and space. This very large database will then serve as a data source for analysis for various other services including but not limited to real time traffic reporting, local government planning, marketing planning, and other services.

Access to this database could then be licensed to interested parties who would be interested in data mining the information whether historic or in real time.

Access to this database could be done manually or through API's that allow direct access to the database.

The systems and methods disclosed herein may utilize any characteristics, features, steps, or components as is known or later developed in the art. See, e.g., U.S. Patent Publication No. 2007/0282621; U.S. Patent Publication No. 2008/0102856; U.S. Patent Publication No. 2009/0100046; U.S. Patent Publication No. 2006/0004590; U.S. Patent Publication No. 2008/0132251; U.S. Patent Publication No. 2008/0132252; U.S. Patent Publication No. 2008/0070593; U.S. Patent Publication No. 2009/0171902; and U.S. Patent Publication No. 2009/0175510, which are hereby incorporated by reference in their entirety.

It should be understood from the foregoing that, while particular implementations have been illustrated and described, various modifications can be made thereto and are contemplated herein. It is also not intended that the invention be limited by the specific examples provided within the specification. While the invention has been described with reference to the aforementioned specification, the descriptions and illustrations of the preferable embodiments herein are not meant to be construed in a limiting sense. Furthermore, it shall be understood that all aspects of the invention are not limited to the specific depictions, configurations or relative proportions set forth herein which depend upon a variety of conditions and variables. Various modifications in form and detail of the embodiments of the invention will be apparent to a person skilled in the art. It is therefore contemplated that the invention shall also cover any such modifications, variations and equivalents.

What is claimed is:

1. A system for displaying user-associated geo-location information comprising:
a database comprising location and time data for a subject, wherein said subject location and time data is collected via a geo-location tracking device; and
a server in communication with the geo-location tracking device and in communication with a display device, wherein the display device simultaneously shows all the subject's locations within a specified time range, based on the subject location and time data.

2. The system of claim 1 wherein the specified time range is determined by a user of the display device.

3. The system of claim 1 wherein the display device is a computer, a mobile phone, or a personal device assistant.

4. The system of claim 1 wherein the display device shows the subject's location within the specified time range using at least one of the following: a map, a chart, a timeline, or a list.

5. The system of claim 1 wherein the geo-location tracking device is a portable device.

6. The system of claim 5 wherein the geo-location tracking device is at least one of the following: a mobile phone, a personal device assistant, or a laptop computer.

7. The system of claim 1 wherein the subject controls whether a user of the display device can see the subject's location.

8. The system of claim 1 wherein a user of the display device can see the location within a specified time range for multiple subjects.

9. The system of claim 1 wherein a user of the display device is the subject.

10. The system of claim 9 wherein the multiple subjects have access to the user's data.

11. The system of claim 10 wherein a privacy setting determined by the user determines which of the user's data that the multiple subjects can access.

12. The system of claim 1 wherein the display device is configured to allow the user to message the subject on the subject's geo-location tracking device or vice versa.

13. A method for displaying user-associated geo-location information comprising:
collecting subject location and time data using a geo-location tracking device, wherein the subject location and time data includes at least one data point;
storing the subject location and time data within a database;
displaying, on a display device, a map simultaneously showing all the subject's location within a specified time range, based on the subject location and time data.

14. The method of claim 13 wherein the geo-location tracking device, the database, and the display device communicate over a network.

15. The method of claim 13 wherein at least one of the geo-location tracking device, the database, and the display device communicates wirelessly.

16. The method of claim 13 wherein the specified time range is at least one of the following: a current point in time, a point in time in the past, a period of time in the past, a past hour, a past day, a past week, a past month, or a past year.

17. The method of claim 13 wherein the specified time range includes a future time reflecting the subject's anticipated location and time.

18. A system for geo-location experience tracking comprising:
a database comprising location and time data for a user, wherein said user location and time data is collected via a geo-location tracking device; and
a server in communication with the geo-location tracking device and in communication with at least one of: a third party service or user computer, wherein the third party service provides third party user-associated information to the server and the user computer provides additional user-associated information to the server, and wherein the server compares and associates the third party user-associated information or user-associated information with the user location and time data.

19. The system of claim 18 wherein the geo-location tracking device is at least one of the following: a mobile phone, a personal device assistant, or a laptop computer.

20. The system of claim 18 wherein the geo-location tracking device utilizes GNSS, interpolation or extrapolation to determine user location data.

21. The system of claim 18 wherein the third party service includes at least one of the following: social networking site, blog site, an online photo storage, an online video storage, a calendar, or a communications tool.

22. The system of claim 18 wherein the third party service includes publicly available data.

23. The system of claim 22 wherein the publicly available data includes at least one of the following: pictures, video, website information, website data, weather information, traffic information, or online data entries.

24. A method for geo-location experience tracking comprising:
collecting user location and time data using a geo-location tracking device, wherein the user location and time data includes at least one data point;
storing the user location and time data within a database;
querying a third party service for third party user-associated information;
comparing the user location and time data with the third party user-associated information;
associating the third party user-associated information with at least one data point.

25. The method of claim 24 further comprising providing information to the geo-location tracking device based on said associating third party user-associated information with at least one data point.

26. The method of claim 24 further comprising alerting the user when a contact status, location or other aspect has been changed or updated.

27. The method of claim 24 further comprising storing the third party user-associated information that has been associated with at least one data point in the database.
